(19) United States
(12) Patent Application Publication
(10) Pub. No.: US 2021/0213817 A1
(43) Pub. Date: Jul. 15, 2021

(54) AUTOMATED CAR COVER

(71) Applicant: Larry King, Las Vegas, NV (US)

(72) Inventor: Larry King, Las Vegas, NV (US)

(21) Appl. No.: 16/742,713

(22) Filed: Jan. 14, 2020

(51) Int. Cl. B60J 11/02; B60J 11/04

(52) U.S. Cl. CPC B60J 11/02; B60J 11/04

(57) ABSTRACT

An illustrated side view of an exemplary automated car cover device is presented. The automated car cover device is useful for providing a safe and efficient method for covering a car to prevent an exterior of the car from being damaged by the elements, debris, scratches, animals, etc. The automated car cover device further is useful for providing a covering of the car which can be completed by a solo person without being overwhelmed by the size, weight and bulk of the covering. The automated car cover device also provides an easy storage for the covering which can be attached to a hitch of the car or placed on the ground. The device is a canister that houses a reel and a cover. A motor of the device provides the power to extend or retract that cover by rotation of the reel.

### FIELD OF THE INVENTION

This invention relates to car maintenance. More particularly, it relates to exterior covering to maintain a car.

### BACKGROUND

A car (or automobile) is a wheeled motor vehicle used for transportation. Most definitions of car say they run primarily on roads, seat one to eight people, have four tires, and mainly transport people rather than goods.

Cars came into global use during the 20th century, and developed economies depend on them. The year 1886 is regarded as the birth year of the modern car when German inventor Karl Benz patented his Benz Patent-Motorwagen. Cars became widely available in the early 20th century. One of the first cars accessible to the masses was the 1908 Model T, an American car manufactured by the Ford Motor Company. Cars were rapidly adopted in the US, where they replaced animal-drawn carriages and carts, but took much longer to be accepted in Western Europe and other parts of the world.

Cars have controls for driving, parking, passenger comfort, and a variety of lights. Over the decades, additional features and controls have been added to vehicles, making them progressively more complex. These include rear reversing cameras, air conditioning, navigation systems, and in-car entertainment. Most cars in use in the 2010s are propelled by an internal combustion engine, fueled by the combustion of fossil fuels. Electric cars, which were invented early in the history of the car, began to become commercially available in 2008.

There are costs and benefits to car use. The costs to the individual include acquiring the vehicle, interest payments (if the car is financed), repairs and maintenance, fuel, depreciation, driving time, parking fees, taxes, and insurance. The costs to society include maintaining roads, land use, road congestion, air pollution, public health, health care, and disposing of the vehicle at the end of its life. Road traffic accidents are the largest cause of injury-related deaths worldwide.

The personal benefits include on-demand transportation, mobility, independence, and convenience. The societal benefits include economic benefits, such as job and wealth creation from the automotive industry, transportation provision, societal well-being from leisure and travel opportunities, and revenue generation from the taxes. People's ability to move flexibly from place to place has far-reaching implications for the nature of societies.

The costs of car usage, which may include the cost of: acquiring the vehicle, repairs and auto maintenance, fuel, depreciation, driving time, parking fees, taxes, and insurance, are weighed against the cost of the alternatives, and the value of the benefits—perceived and real—of vehicle usage. The benefits may include on-demand transportation, mobility, independence and convenience. During the 1920s, cars had another benefit: “couples finally had a way to head off on unchaperoned dates, plus they had a private space to snuggle up close at the end of the night.”

Other costs are contained in the upkeep of the car. The paint, metal and interior of the vehicle are costly to maintain and repair when damaged. To protect these particular aspects of the car, many individuals resort to covering the car with a tarp. The manual aspect of covering a car may require two individuals or one individual struggling. The tarps or covers to cover a car are heavy, large in size and difficult to control.

In light of the foregoing, there is a need for a device to provide a safe, efficient and effective method to protect an automobile from the elements, break-in and other harmful effects.

### BRIEF DESCRIPTION OF THE DRAWINGS

FIG. 1 is an illustrated side view of an exemplary automated car cover device.

FIG. 2 is an illustrated top view of the exemplary automated car cover device shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

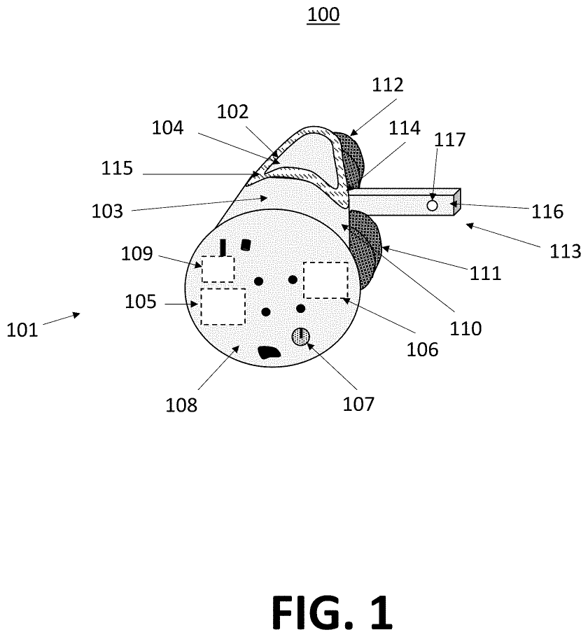

Referring to FIG. 1, an illustrated side view of an exemplary automated car cover device 100 is presented. The automated car cover device 100 is useful for providing a safe and efficient method for covering a car to prevent an exterior of the car from being damaged by the elements, debris, scratches, animals, etc. The automated car cover device 100 further is useful for providing a covering of the car which can be completed by a solo person without being overwhelmed by the size, weight and bulk of the covering. The automated car cover device 100 also provides an easy storage for the covering which can be attached to a hitch of the car or placed on the ground.

The automated car covering device 100 has a canister 101. The canister 101 of the automated car covering device 100 preferably has a cylindrical shape, but other shapes are hereby contemplated, such as, but not limited to, rectangular, square, oblong, round, etc. The canister 101 of the automated car covering device 100 is preferably made of a sheet metal material, but other materials are hereby contemplated, including, but not limited to, steel, aluminum, poly-vinyl chloride (PVC), etc.

The canister 101 of the automated car covering device 100 preferably has a height of eight (8) inches, but other heights are hereby contemplated, including, but not limited to, six (6) inches, ten (10) inches, eleven (11) inches, etc. The canister 101 of the automated car covering device 100 preferably has a length of twenty-two (22) inches, but other lengths are hereby contemplated, including, but not limited to, twenty (20) inches, twenty-three (23) inches, twenty-six (26) inches, etc. The canister 101 of the automated car covering device 100 preferably has a width of eight (8) inches, but other widths are hereby contemplated, including, but not limited to, six (6) inches, ten (10) inches, eleven (11) inches, etc. The size of the canister 101 of the automated car covering device 100 may be determined by the size of a covering to be used depending on the size of the car.

The canister 101 of the automated car covering device 100 has an opening 102. The opening 102 of the canister 101 of the automated car covering device 100 is preferably along a horizontal length 103 of the canister 101 of the automated car covering device 100. The opening 102 of the canister 101 of the automated car covering device 100 is useful for providing access to an interior 104 of the canister 101.

The canister 101 of the automated car covering device 100 has a motor 105, a power source 106 and an actuator 107. The motor 105 of the canister 101 of the automated car covering device 100. The motor 105 is electrically coupled to the power source 106. The power source 106 is preferably a battery, where the battery is preferably rechargeable, but other types of power sources are hereby contemplated, including, but not limited to, solar, NiCad, diesel, gasoline, etc.

The actuator 107 is communicatively coupled to the motor 105 of the canister 101 and provides the ability to turn the automated car covering device on or off, speed, pause, etc. The actuator 107 is securely coupled to a first end 108 of the canister 101 of the automated car covering device 100. The actuator 107 of the canister 101 is preferably a knob, but other types of actuators are hereby contemplated, including, but not limited to, toggle, button, touch-screen, etc.

Optionally and/or additionally, the motor 105 of the canister 101 of the automated car covering device 100 may be electrically coupled to a remote-control transceiver 109. The remote-control transceiver 109 is communication coupled to a remote control (not shown). The remote control is preferably an app on a computing device, but other types of remote controls are hereby contemplated, including, but not limited to, control device, remote button, etc.

On a first side 110 of the canister 101 of the automated car covering device 100 are one or more wheels 111, 112. The one or more wheels 111, 112 are useful for transport of the automated car covering device 100. The one or more wheels 111, 112 are preferably rubber wheels, but other types of wheels are hereby contemplated, including, but not limited to, air-filled wheels, plastic wheels, steel wheels, etc.

To make the transport of the automated car covering device 100 easier and for longer distances, optionally and/or additionally a bar 113 is coupled to a middle 114 of the first side 110 of the canister 101 of the automated car covering device 100. A first portion 116 of the bar 113 preferably has a hole 117. The hole 117 supports a coupling to a hitch of a car.

Optionally and/or additionally, the opening 102 of the canister 101 of the automated car covering device 100 may have a cover 115. The cover 115 is useful in protecting the interior 104 of the canister 101 of the automated car covering device 100 when not in use.

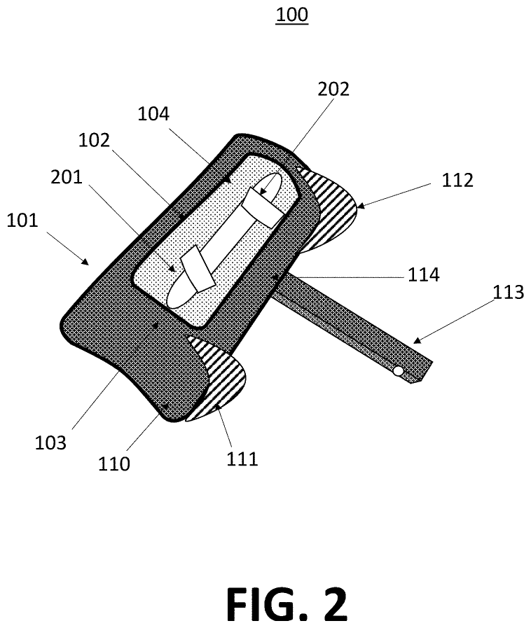

Moving now to FIG. 2, an illustrated top 201 view of the exemplary automated car cover device 100 shown in FIG. 1 is presented.

The canister 101 of the automated car covering device 100 has an opening 102. The opening 102 of the canister 101 of the automated car covering device 100 is preferably on the horizontal length 103 of the canister 101 of the automated car covering device 100. The opening 102 of the canister 101 of the automated car covering device 100 is useful for providing access to the interior 104 of the canister 101.

The canister 101 of the automated car covering device 100 has the motor 105 shown in FIG. 1, the power source 106 shown in FIG. 1 and the actuator 107 shown in FIG. 1. The motor 105 of the canister 101 of the automated car covering device 100. The motor 105 is electrically coupled to the power source 106.

The actuator 107 is communicatively coupled to the motor 105 of the canister 101 and provides the ability to turn the automated car covering device on or off, speed, pause, etc. The actuator 107 is securely coupled to the first end 108 shown in FIG. 1 of the canister 101 of the automated car covering device 100.

On a first side 110 of the canister 101 of the automated car covering device 100 are one or more wheels 111, 112. The one or more wheels 111, 112 are useful for transport of the automated car covering device 100.

To make the transport of the automated car covering device 100 easier and for longer distances, optionally and/or additionally a bar 113 is coupled to a middle 114 of the first side 110 of the canister 101 of the automated car covering device 100. A first portion 116 of the bar 113 preferably has a hole 117. The hole 117 supports a coupling to a hitch of a car.

The interior 104 of the opening 102 of the horizontal length 103 of the canister 101 of the automated car covering device 100 has a reel 201 and a cover 202. The reel 201 is configured to have the cover 202 for storage and further the reel 201 is configured to rotate such that the cover 202 can be extended or retracted.

The reel 201 is mechanically coupled to the motor 105 shown in FIG. 1. The motor 105 shown in FIG. 1 is coupled to the actuator 106 shown in FIG. 1. Thus, a user can actuate the reel 201 to release or extend the cover 202 to cover the car. Further, the motor 105 shown in FIG. 1 can be actuated by the actuator to retract and retain the cover 202 on the reel 201 for storage and/or future use. The cover 202 being flexible. The cover being made of a plastic material, but other materials are hereby contemplated, including, but not limited to, cloth, wool, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An automated car covering device for protecting a car, the device comprising:
a canister, the canister having an opening along a horizontal length of the canister;
a reel, the reel being on an interior of the canister, wherein the reel being accessible by the opening of the canister;
a cover, the cover being removably coupled to the reel; and
a motor, the motor being actuated by an actuator, the motor being powered by a power source, wherein the motor being coupled to the reel, and wherein the motor being for rotating the reel to extend the cover.

2. The device of claim 1, wherein the canister being eight (8) inches in height.

3. The device of claim 1, wherein the canister being twenty-two (22) inches in length.

4. The device of claim 1, wherein the canister being eight (8) inches in width.

5. The device of claim 1, wherein the canister being made of a stainless-steel metal.

6. The device of claim 1, wherein the cover being flexible.

7. The device of claim 1, wherein the cover being made of a plastic material.

8. The device of claim 1, wherein the device further comprising:
a remote transceiver, the remote transceiver being coupled to the motor;
the remote transceiver being communicatively coupled to a remote control.

9. The device of claim 8, wherein the remote control being an app on a computing device.

10. The device of claim 1, wherein the device further comprising:
a bar, the bar being for transporting the device; and
one or more wheels, one or more wheels being coupled to the canister, wherein the one or more wheels being for moving of the device.

11. The device of claim 10, wherein the bar further comprises:
a hole, the hole being configured at a first end of the bar, wherein the hole for being coupled to a hitch of a car.

12. The device of claim 10, wherein the one or more wheels being made of a rubber material.

13. The device of claim 1, wherein the opening having a cover.

14. The device of claim 13, wherein the cover being removable.

15. The device of claim 1, wherein the actuator being a knob.

16. The device of claim 1, wherein the power source being a battery.
